(19) United States
(12) Patent Application Publication
(10) Pub. No.: US 2017/0079327 A1
(43) Pub. Date: Mar. 23, 2017

(54) POWER SUPPLY DEVICE FOR ELECTRONIC ATOMIZER

(71) Applicant: SHENZHEN JIESHIBO TECHNOLOGY CO., LTD., Shenzhen (CN)

(72) Inventors: Jianyong Wu, Shenzhen (CN); Guojie Jiang, Shenzhen (CN); Jianhua Zhao, Shenzhen (CN); Weijun Xiao, Shenzhen (CN); Qiang Chen, Shenzhen (CN)

(21) Appl. No.: 14/964,596

(22) Filed: Dec. 10, 2015

(30) Foreign Application Priority Data
Sep. 22, 2015 (CN) 201520736458.3

(51) Int. Cl. A24F 47/00; H05B 1/02; H02J 7/00

(52) U.S. Cl. CPC A24F 47/008; H02J 7/0042; H02J 7/007; H05B 1/0244

(57) ABSTRACT

Disclosed is a power supply device for electronic atomizer, which includes a housing having a battery compartment formed therein, at least a battery installed in the battery compartment and a control circuit having an input side electrically connected with the battery and an output side electrically connected with an output electrode terminal. The control circuit includes a microcontroller unit, a mode selection module connected with the microcontroller unit for selecting working mode of the electronic atomizer, a regulation module connected with the microcontroller unit for regulating working parameter of the electronic atomizer and a start button connected with the microcontroller unit for controlling whether the electronic atomizer starts up. The mode selection module is a multi-position switch and the microcontroller unit is able to being triggered to start corresponding working modes by switching the multi-position switch to be different positions. The present invention has the advantage of convenient to use.

### CROSS-REFERENCE TO RELATED APPLICATIONS

This present invention claims the benefit of Chinese Patent Application No. 201520736458.3, filed on Sep. 22, 2015; the contents of which are hereby incorporated by reference.

### FIELD OF THE INVENTION

The present invention relates to power supply devices, and more particularly to a power supply device for electronic atomizer.

### BACKGROUND OF THE INVENTION

Electronic atomizer, which is generally used to atomize spices and medicines, has already and gradually been accepted by the customer and become more and more popular. And in general, the electronic atomizer includes an atomizer and a power supply device for supplying power to the atomizer so that a heating wire provided in the atomizer can produce heat and then the liquid contacting with the heating wire can be heated and finally be atomized into vapors which can be inhaled by the user.

Generally, the power supply device used for the electronic atomizer includes a control circuit for controlling the power supply device. The input side of the control circuit is electrically connected with a battery of the power supply device and the output side thereof is electrically connected with an output electrode terminal and in turn electrically connected with the atomizer via the output electrode terminal, thereby supplying power to the atomizer. In order to satisfy the needs of the users, the control circuit is generally configured to have more than one working mode, such as temperature regulation mode, power regulation mode and so on, thus the user can choose one of the working modes of the electronic atomizer according to actual needs. In the existing technology, the control circuit of the power supply device is provided with a mode selection module for selecting working mode of the electronic atomizer and a regulation module for regulating working parameter of the electronic atomizer. The mode selection module includes at least two mode selection keys which are in opposition to each other, and corresponding working modes can be stated up by pressing different mode selection keys. The regulation module includes two regulation keys which are independent of each other, and the working parameters can be regulated by pressing different regulation keys. Because the mode selection and parameter regulation are achieved by using several keys which are independent of each other, when using the electronic atomizer, the user needs to press more than one key simultaneously to finish a control operation. For example, when need to regulate the working temperature of the electronic atomizer, the user needs to press the mode selection key corresponding to the temperature regulation mode and the regulation key at the same time, thus it is extremely inconvenient to use.

Furthermore, the cover plate of the battery compartment of the existing electronic atomizer is generally fixed via screws, thus, when need to change the battery, only using a screwdriver to remove the screws can the battery be taken out and then be changed. Thus it is extremely inconvenient to change battery for user.

### SUMMARY OF THE INVENTION

One object of the present invention is to provide a power supply device for electronic atomizer, which is convenient to control and operate for user.

Another object of the present invention is to provide a power supply device for electronic atomizer, which is convenient to change battery for user.

To achieve above objects, there are provided technical solutions as follows:

A power supply device for electronic atomizer includes: a housing, which has a battery compartment formed therein; at least a battery, which is installed in the battery compartment; and a control circuit, an input side of which is electrically connected with the battery installed in the battery compartment and an output side of which is electrically connected with an output electrode terminal. The control circuit includes a microcontroller unit, a mode selection module connected with the microcontroller unit for selecting working mode of the electronic atomizer, a regulation module connected with the microcontroller unit for regulating working parameter of the electronic atomizer and a start button connected with the microcontroller unit for controlling whether the electronic atomizer starts up. The mode selection module is a multi-position switch and the microcontroller unit is able to being triggered to start corresponding working modes by switching the multi-position switch to be different positions.

In the above power supply device for electronic atomizer, an opening of the battery compartment is covered with a cover plate which includes a cover plate body; the cover plate body has a connecting end hinged at a side of the opening of the battery compartment and a free end having a containing space; a locking element which is able to move in horizontal direction is provided in the containing space, a spring is provided at a rear end of the locking element and a locking groove is provided at a side, which is corresponding to the free end of the cover plate body, of the opening of the battery compartment; and when the opening of the battery compartment being covered with the cover plate, the locking element is able to be pushed forward by the spring so that a front end of the locking element is able to insert into the locking groove.

The present invention has some good technical effects as follows: according to the power supply device for electronic atomizer of the present invention, a multi-position switch is taken as working mode selection switch and the microcontroller unit is able to being triggered to start corresponding working modes by switching the multi-position switch to be different positions, thereby achieving the selection of different working modes. When using the electronic atomizer, the user can select working mode by switching the multi-position switch to be a corresponding position and then regulate the working parameter by means of the regulation module, thus it improves the convenience of the operation greatly. Furthermore, when need to change the battery, the user can push the locking element backward so that the locking element moves backward and the spring is pressed by the locking element and then the front end of the locking element moves away from the locking groove, thus the cover plate of the battery compartment can be opened and the battery can be changed. After finishing the change of battery, the user can push the cover plate upward so as to make the front end of the locking element insert into the locking groove, thereby the opening is covered with the cover plate. The cover plate of the battery compartment can be opened or closed by user without a tool such as screwdriver and so on, thus it is convenient to change the battery for users.

### BRIEF DESCRIPTION OF THE DRAWINGS

FIG. 1 is a perspective view illustrating an electronic atomizer;

FIG. 2 is a section view illustrating a power supply device according to an embodiment of the present invention;

FIG. 3 is a section view illustrating the cover plate of battery compartment of the power supply device being open according to an embodiment of the present invention;

FIG. 4 is a perspective view illustrating the cover plate of battery compartment of the power supply device being open according to an embodiment of the present invention;

FIG. 5 is a block diagram illustrating the control circuit of the power supply device according to an embodiment of the present invention;

FIG. 6 is a schematic diagram illustrating a connection between the multi-position rotary switch and the microcontroller unit; and

FIG. 7 is a section view illustrating the cover plate of the battery compartment.

### DETAILED DESCRIPTION OF ILLUSTRATED EMBODIMENTS

Some embodiments of the present invention will be described as follows, by way of example only, with reference to the accompanying drawings.

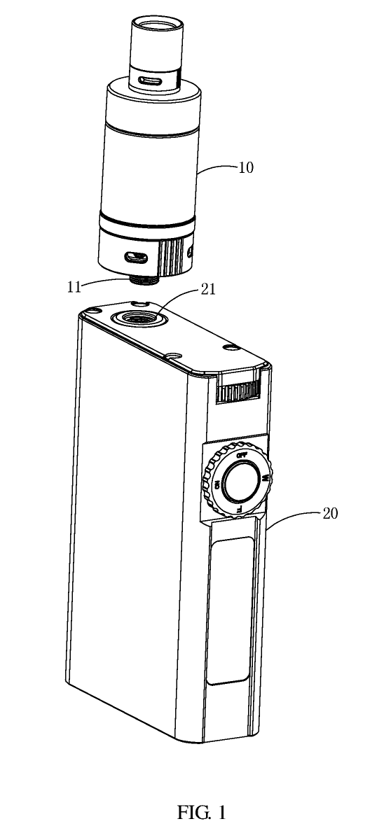

Referring to FIG. 1, the electronic atomizer includes an atomizer 10 and a power supply device 20 connected with the atomizer 10. The power supply device 20 has an output electrode terminal 21 and the atomizer 10 has an input electrode terminal 11 to match with the output electrode terminal 21. According to the embodiment shown in the figures, the output electrode terminal 21 is provided with internal thread and the input electrode terminal 11 is provided with external thread matching with the internal thread of the output electrode terminal 21. The input electrode terminal 11 is screwed with the output electrode terminal 21 so that the atomizer 10 is electrically connected with the power supply device 20 and then the power supply device 20 is able to supply power for the atomizer 10 so as to heat the heating wire (not shown in FIG. 1) of the atomizer 10.

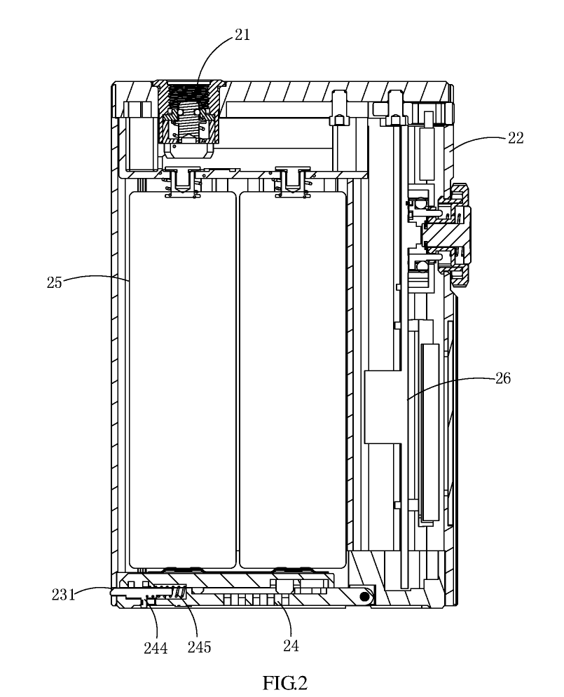

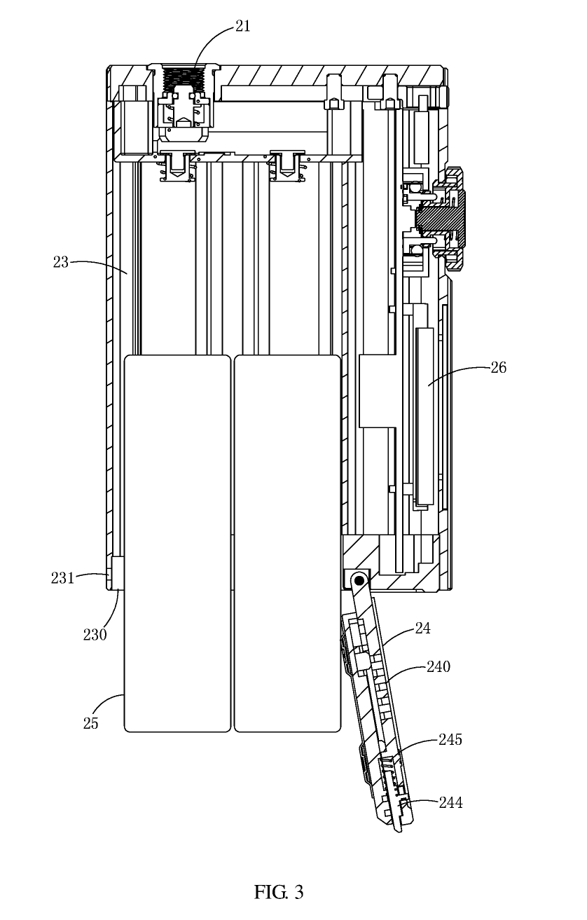

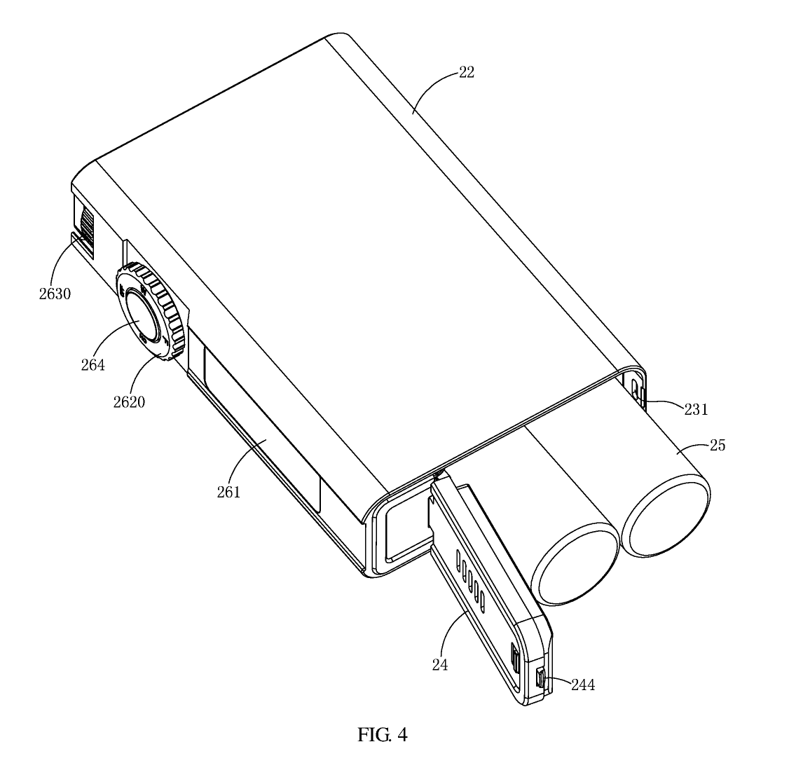

Referring to FIG. 2 to FIG. 6, the power supply device 20 for electronic atomizer includes a housing 22, a battery compartment 23 formed in the housing 22, a cover plate 24 with which the opening 230 of the battery compartment 23 is covered, at least a battery 25 installed in the battery compartment 23 and a control circuit 26 arranged in the housing 22. In this preferred embodiment, the housing 22 is designed to be rectangle shape and it has four longitudinal corner angles which have been rounded, thereby improving comfort when holding the power supply device 20.

The input side of the control circuit 26 is electrically connected with the battery 25 installed in the battery compartment 23, and the output side of the control circuit 26 is electrically connected with the output electrode terminal 21. The control circuit 26 is provided for controlling working state of the power supply device 20.

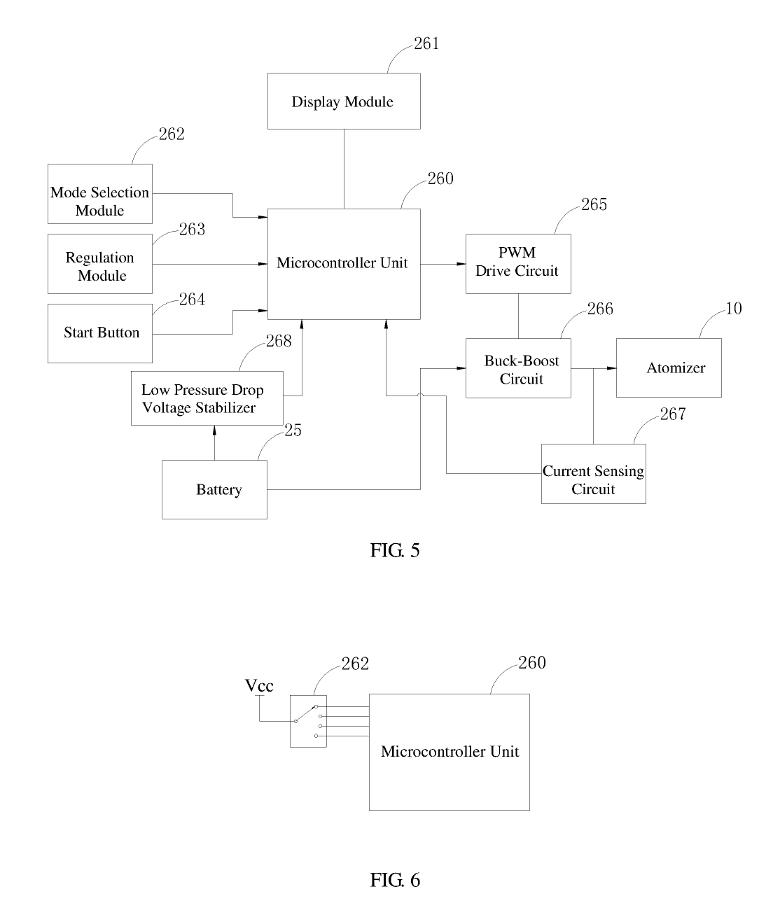

FIG. 5 illustrates the control circuit 26 according to an embodiment. In this embodiment, the control circuit 26 includes a microcontroller unit (MCU) 260, a display module 261 connected with the microcontroller unit 260 for displaying working state of the electronic atomizer, a mode selection module 262 connected with the microcontroller unit 260 for selecting working mode of the electronic atomizer, a regulation module 263 connected with the microcontroller unit 260 for regulating working parameter of the electronic atomizer, a start button 264 connected with the microcontroller unit 260 for controlling whether the electronic atomizer starts up, a Buck-Boost circuit 266 connected with the microcontroller unit 260 via a PWM drive circuit 265 and a current sensing circuit 267 connected to output side of the Buck-Boost circuit 266 for detecting an output current of the Buck-Boost circuit 266. The microcontroller unit 260 is configured to be able to control the electronic atomizer to work in more than one working mode. It should be noted that the above working modes are well known for a person skilled in the art, thus it does not need to be repeated here. The battery 25 has two outputs, one being connected with the microcontroller unit 260 for supplying power to the microcontroller unit 260, and the other one being connected with input side of the Buck-Boost circuit 266 and then outputted to the atomizer 10 after regulating voltage by the Buck-Boost circuit 266, thereby driving the heating wire to produce heat. According to working mode selected by the mode selection module 262 and working parameter set by the regulation module 263, the microcontroller unit 260 is able to produce and send a control signal to the PWM drive circuit 265, and then the PWM drive circuit 265 is able to produce and send a PWM pulse signal to the Buck-Boost circuit 266 according to the control signal, so as to control the working state of the Buck-Boost circuit 266, thereby regulating the voltage outputted to the atomize 10. Meanwhile, according to the output current of the Buck-Boost circuit 266 detected by the current sensing circuit 267, the microcontroller unit 260 is able to regulate the control signal outputted to the PWM drive circuit 265, thereby regulating output voltage of the Buck-Boost circuit 266 to be a preset value.

In some embodiments, a microcontroller including a Cotex M3 processor produced by Advanced RISC Machines is taken as the microcontroller unit 260. However, it should be noted that the control circuit 26 of the power supply device 20 is not limited to the embodiments shown in FIG. 5, and in different embodiments, the control circuit 26 can be provided with different functional modules.

In some embodiments, the mode selection module 262 is a multi-position rotary switch. By means of switching the multi-position rotary switch to be different positions, the multi-position rotary switch can send a trigger signal to different trigger pins, which is corresponding to different working modes, of the microcontroller unit, thereby achieving the selection of different working modes. FIG. 6 illustrates a connection relationship between the multi-position rotary switch and the microcontroller unit 260. A common terminal of the multi-position rotary switch is connected to a Vcc, such as a supply voltage of +3V supplied by the battery 25, and several tap position terminals are connected with the trigger pins (I/O pins) of the microcontroller unit 260, respectively. The multi-position rotary switch can be rotated to different positions by the user, so as to send a trigger signal to corresponding I/O pin of the microcontroller unit 260, thereby driving the electronic atomizer to start a corresponding working mode.

In some preferred embodiments, there is a circular regulating element 2620 fixed on a rotating shaft of the multi-position rotary switch and the circular regulating element 2620 is provided at a side of the housing 22 so that the user can control the multi-position rotary switch by operating the circular regulating element 2620. Preferably, the start button 264 is provided at a middle of the circular regulating element 2620 so as to form a compact design and it is easy to operate for user.

According to the embodiments illustrated in the figures, the multi-position rotary switch is chosen as the mode selection module 262, while in other embodiments, other type of multi-position switches, such as multi-position thumbwheel switch, also can be chosen as the mode selection module 262.

Referring to the figures, in some embodiments, the regulation module 263 is a thumbwheel switch, a fan-shaped regulating element 2630 of which is exposed to a side of the housing 22 so that it is easy to operate the thumbwheel switch for user. Compared with the existing way of regulating the working parameter via two separate regulating keys, the above design of taking the thumbwheel switch as the regulation module 263 for regulating working parameter of the electronic atomizer is easier to operate.

When working, one of the working modes of the electronic atomizer can be selected by means of the mode selection module 262 and working parameter can be set by means of the regulation module 263, in the case that the electronic atomizer has been started up by pressing the start button 264, a control signal will be produced by the microcontroller unit 260 according to the information about the selected working mode and working parameter, and then the control signal will be sent to the PWM drive circuit 265, a PWM pulse signal will be produced by the PWM drive circuit 265 and be sent to the Buck-Boost circuit 266 so as to control the Buck-Boost circuit 266 to be switch-on or cut-off, thereby regulating the voltage outputted by the battery 25 and then sending it to the atomizer 10 so as to drive the heating wire of the atomizer 10 to produce heat. After the electronic atomizer starts up, the output current of the Buck-Boost circuit 266 will be detected in real time by the current sensing circuit 267 and the detected output current will be sent to the microcontroller unit 260 and then the microcontroller unit 260 will regulate the control signal according to the output current, thereby regulating the output voltage of the power supply device 20.

In some preferred embodiments, there is a low pressure drop voltage stabilizer 268 connected between the battery 25 and the microcontroller unit 260 for steadying the voltage outputted to the microcontroller unit 260 by the battery 25, thereby preventing the microcontroller unit 260 from being damaged due to voltage fluctuation.

According to the power supply device 20 of the present invention, a multi-position switch is chosen as the mode selection module of the control circuit 26. By means of switching the multi-position switch to be different positions, the microcontroller unit 260 will be triggered to achieve corresponding working modes, thereby achieving the selection of different working modes. When using the electronic atomizer, the user can firstly select a working mode by switching the multi-position switch to be a corresponding position and then regulate the working parameter via the regulation module 263, thus it improves the convenience of the operation greatly.

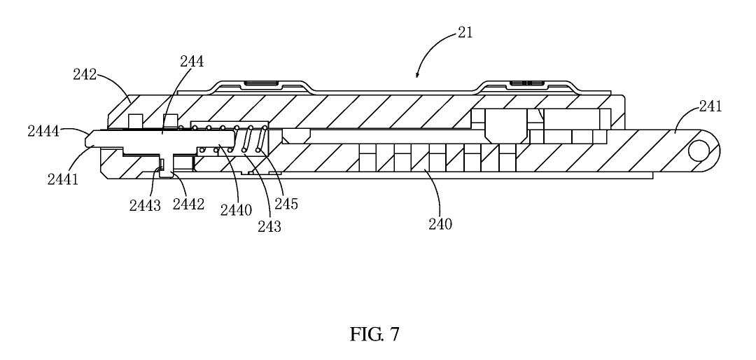

As shown in FIG. 7, the cover plate 24 includes a cover plate body 240 which has a connecting end 241 hinged at a side of the opening 230 of the battery compartment 23 and a free end 242 having a containing space 243. A locking element 244, which is able to move in horizontal direction, is provided in the containing space 243 and a spring 245 is provided at a rear end 2440 of the locking element 244. A locking groove 231 is provided at a side, which is corresponding to the free end 242 of the cover plate body 240, of the opening 230 of the battery compartment 23. When the opening 230 of the battery compartment 23 being buckled by the cover plate 24, the spring 245 will push the locking element 244 so as to make a front end 2441 of the locking element 244 insert into the locking groove 231, thereby achieving the fixation of the cover plate 24.

When need to change the battery 25, the user can push the locking element 244 backward so that the locking element 244 moves backward and the spring 245 is pressed by the locking element 244 and then the front end 2441 of the locking element 244 moves away from the locking groove 231, thus the cover plate 24 of the battery compartment 23 is opened and the battery 25 can be changed. After finishing the change of battery 25, the user can push the cover plate 24 upward so as to make the front end 2441 of the locking element 244 insert into the locking groove 231, thereby the opening 230 is covered with the cover plate 24. The cover plate 24 of the battery compartment 23 can be opened or closed by user without a tool such as screwdriver and so on, thus it is convenient to change the battery 25 for user.

Referring to FIG. 7, in some preferred embodiments, there is a handle portion 2442 extending from a middle of the locking element 244 and exposed to the cover plate body 240. The handle portion 2442 is provided to be operated by the user so that the locking element 244 can be pushed backward easily by the user. Preferably, there is a recess 2443 formed on a front side surface of the handle portion 2442. By means of the recess 2443, the user can operate the handle portion 2442 so as to push the locking element 244 easily.

Referring to FIG. 7, in some preferred embodiments, there is an inclined surface 2444 formed on a top of front side 2441 of the locking element 244. When closing the cover plate 24 of the battery compartment 23, the locking element 244 is pressed by an edge of the locking groove 231 along the inclined surface 2444 so that the locking element 244 moves backward and the front side 2441 thereof enters into the cover plate body 240.

Preferably, a rechargeable lithium battery, which has advantages of high specific energy and reusability, is chosen as the battery 25. However, it should be noted that other kinds of batteries which is suitable for the present invention also can be chosen as the battery 25.

Above descriptions of embodiments are provided for further illustrating the technical content of the present invention, so as to facilitate understanding and it should be understood that the invention is not to be limited to the disclosed embodiments. Any technique extension and recreation according to the present invention should be included within the scope of protection of the invention.

What is claimed is:

1. A power supply device for electronic atomizer, comprising:
a housing, which has a battery compartment formed therein;
at least a battery, which is installed in the battery compartment; and
a control circuit, an input side of which is electrically connected with the battery installed in the battery compartment and an output side of which is electrically connected with an output electrode terminal, the control circuit comprising a microcontroller unit, a mode selection module connected with the microcontroller unit for selecting working mode of the electronic atomizer, a regulation module connected with the microcontroller unit for regulating working parameter of the electronic atomizer and a start button connected with the microcontroller unit for controlling whether the electronic atomizer starts up, wherein the mode selection module is a multi-position switch and the microcontroller unit is able to being triggered to start corresponding working modes by switching the multi-position switch to be different positions.

2. The power supply device for electronic atomizer according to claim 1, wherein the multi-position switch is multi-position rotary switch or multi-position toggle switch.

3. The power supply device for electronic atomizer according to claim 1, wherein the multi-position switch is multi-position rotary switch and there is a circular regulating element provided at a side of the housing and fixed on a rotating shaft of the multi-position rotary switch.

4. The power supply device for electronic atomizer according to claim 3, wherein the start button is provided at a middle of the circular regulating element.

5. The power supply device for electronic atomizer according to claim 1, wherein the regulation module is a thumbwheel switch, a fan-shaped regulating element of which is exposed to a side of the housing.

6. The power supply device for electronic atomizer according to claim 1, wherein the control circuit further comprises a display module connected with the microcontroller unit for displaying working state of the electronic atomizer and a Buck-Boost circuit connected with the microcontroller unit via a PWM drive circuit; one of outputs of the battery is connected with the microcontroller unit for supplying power to the microcontroller unit, and the other one of outputs of the battery is connected with an input side of the Buck-Boost circuit and then outputs a voltage regulated by the Buck-Boost circuit to the atomizer; according to a working mode selected by the mode selection module and a working parameter set by the regulation module, the microcontroller unit is able to produce and send a control signal to the PWM drive circuit, and then the PWM drive circuit is able to produce and send a PWM pulse signal to the Buck-Boost circuit according to the control signal so as to control the working state of the Buck-Boost circuit, thereby regulating a voltage outputted to the atomizer.

7. The power supply device for electronic atomizer according to claim 6, wherein the control circuit further comprises a current sensing circuit connected to an output side of the Buck-Boost circuit for detecting an output current of the Buck-Boost circuit, according to the output current of the Buck-Boost circuit detected by the current sensing circuit, the microcontroller unit is able to regulate the control signal outputted to the PWM drive circuit, thereby regulating an output voltage of the Buck-Boost circuit to be a preset value.

8. The power supply device for electronic atomizer according to claim 7, wherein there is a low pressure drop voltage stabilizer connected between the battery and the microcontroller unit.

9. The power supply device for electronic atomizer according to claim 1, wherein an opening of the battery compartment is covered with a cover plate which comprises a cover plate body; the cover plate body has a connecting end hinged at a side of the opening of the battery compartment and a free end having a containing space; a locking element which is able to move in horizontal direction is provided in the containing space, a spring is provided at a rear end of the locking element and a locking groove is provided at a side, which is corresponding to the free end of the cover plate body, of the opening of the battery compartment; and when the opening of the battery compartment being covered with the cover plate, the locking element is able to be pushed forward by the spring so that a front end of the locking element is able to insert into the locking groove.

10. The power supply device for electronic atomizer according to claim 9, wherein there is a handle portion extending from a middle of the locking element and exposed to the cover plate body.

11. The power supply device for electronic atomizer according to claim 10, wherein there is a recess formed on a front side surface of the handle portion.

12. The power supply device for electronic atomizer according to claim 9, wherein there is an inclined surface formed on a top of front side of the locking element.

13. The power supply device for electronic atomizer according to claim 10, wherein there is an inclined surface formed on a top of front side of the locking element.

14. The power supply device for electronic atomizer according to claim 11, wherein there is an inclined surface formed on a top of front side of the locking element.
